(19) United States
(12) Patent Application Publication
(10) Pub. No.: US 2004/0073620 A1
(43) Pub. Date: Apr. 15, 2004

(54) Home network system for generating random number and method for controlling the same

(75) Inventors: Young Hoon Roh, Seoul (KR); Jung Ho Kim, Seoul (KR); Jin Cheol Cho, Seoul (KR); Jae Won Chang, Seoul (KR); Sang Hyuk Kang, Pusan (KR); Sang Mahn Kim, Kyunggi-do (KR); Pan Su Kim, Kyunggi-do (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 10/679,481

(22) Filed: Oct. 7, 2003

(30) Foreign Application Priority Data
Oct. 10, 2002 (KR) 2002-61855

(51) Int. Cl. G06F 15/16

(52) U.S. Cl. 709/208

(57) ABSTRACT

A method for operating a home network system which can allow a home server appliance to assign, to a client appliance newly connected to a home network, a unique ID (Identifier or Identity) different from IDs assigned to already connected client appliances, such that all home appliances connected to the home network can be appropriately controlled. As a unique ID is assigned to the client appliance newly connected to the home network so that the newly connected client appliance is automatically bound to the home network, it is assured that different IDs are assigned to the client appliances, made by different manufacturers, connected to the home network. Therefore, a plurality of client appliances can be appropriately discriminated and controlled and the reliability of a control operation can be improved in the home network system.

### BACKGROUND OF THE INVENTION

1. Field of the Invention

The present invention relates to a home network system for generating a random number and a method for controlling the same, and more particularly to a home network system for generating a random number and a method for controlling the same which can allow a home server appliance to assign, to a client appliance newly connected to a home network, a unique ID (Identifier or Identity) different from IDs assigned to already connected client appliances, such that all home appliances connected to the home network can be appropriately controlled.

2. Description of the Related Art

Recently, home network systems have been developed and supplied. A home network system connects a plurality of home appliances used in a general home to one network that is connected to an external Internet network so that the home appliances can be controlled within the home or remotely.

The configuration of a conventional home network system will now be described with reference to FIG. 1.

In particular, a manager of the home network system can input a control command by means of a home appliance connected to a home network N, and can control a plurality of home appliances by means of the home appliance equipped with input and output units in a central control manner so that each home appliance operates in response to the control command and outputs information of its operating state. Here, the home appliance equipped with the input and output units is referred to as a “home server appliance” HS.

The home server appliance HS processes control signals to be transmitted to and received from the plurality of home appliances, e.g., a refrigerator, an air conditioner, etc., connected to the home network N, and includes hardware equipped with an Internet module so that the home server appliance HS can be connected to the external Internet network. For example, the home appliances such as the refrigerator, the air conditioner, etc. can be used for the home server appliance.

Each of the remaining home appliances other than the home server appliance performs an operation corresponding to a control command inputted through the home server appliance HS, and transmits a result of the control operation to the home server appliance. Here, the remaining home appliances are referred to as “client appliances” C1 to C4. A microcomputer is embedded in each of the client appliances C1 to C4, and processes data to be transmitted and received through the home network N.

In other words, the client appliances C1 to C4 such as a washing machine, a microwave oven, etc. and the home server appliance HS such as the refrigerator are connected through the home network N so that control signals are transmitted and received. If necessary, an Internet module for connecting the home server appliance HS to an external Internet network I is additionally provided, such that the home network N is connected to the external Internet network I. In this case, a remote controller accessing the Internet network can remotely control the home appliances connected to the home network N.

However, in order for the client appliances to be controlled through the home server appliance HS, the home server appliance HS assigns a basic ID (Identifier or Identity) having a manufacturer's serial number of the microcomputer embedded in each of the client appliances to discriminate the client appliances C1 to C4, and transmits and receives a control signal through a basic ID invocation.

For this, a manager of the home network N must confirm a manufacturer's serial number of the microcomputer embedded in each home appliance and manually input the manufacturer's serial number in the home server appliance HS so that the home server appliance HS can recognize the manufacturer's serial number as the basic ID. However, the above-described procedure is complex. Furthermore, different serial numbers must be assigned so that a manufacturer's serial number of the microcomputer embedded in each of the client appliances C1 to C4 is not equal to that of the microcomputer of another home appliance. However, it is difficult for the different serial numbers to be assigned to all home appliances since manufacturers of microcomputers are different.

### SUMMARY OF THE INVENTION

Therefore, the present invention has been made in view of the above problems, and it is an object of the present invention to provide a method for operating a home network system, which can allow a manufacturer's serial number of a microcomputer embedded in a client appliance newly connected to a home network as a basic ID (Identifier or Identity) to be automatically inputted into a home server appliance, and allow an arbitrarily generated random number to be assigned as the basic ID of the newly connected client appliance if the basic ID of the newly connected client appliance is equal to that of an already connected client appliance, such that a plurality of client appliances connected to the home network can be stably controlled and a manual ID input procedure by a user can be omitted.

In accordance with one aspect of the present invention, the above and other objects can be accomplished by the provision of a home network system for generating a random number, comprising: a plurality of client appliances connected to a home network, each of the client appliances being controlled in response to a received control command; a plurality of client communication modules for converting a format of data to be transmitted and received between the client appliances and the home network; a home server appliance for inputting the control command into each of the client appliances, assigning a manufacturer's serial number of the client appliance as an ID (Identifier or Identity) of the client appliance, generating a random number if the manufacturer's serial number of the client appliance is equal to an ID of another client appliance, and assigning the generated random number as the ID of the client appliance; and a home server communication module for converting a format of data to be transmitted and received between the home server appliance and the home network.

In accordance with another aspect of the present invention, there is provided a method for controlling a home network system that generates a random number, comprising the steps of: (a) allowing a client appliance newly connected to a home network to transmit information of a manufacturer's serial number to a home server appliance; (b) allowing the home server appliance to assign, to the client appliance, an ID (Identifier or Identity) based on the manufacturer's serial number of the client appliance or a random number generated through a random number generation operation; and (c) allowing the client appliance to store the ID and allowing the home server appliance to transmit a control command using the ID.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating a conventional home network system;

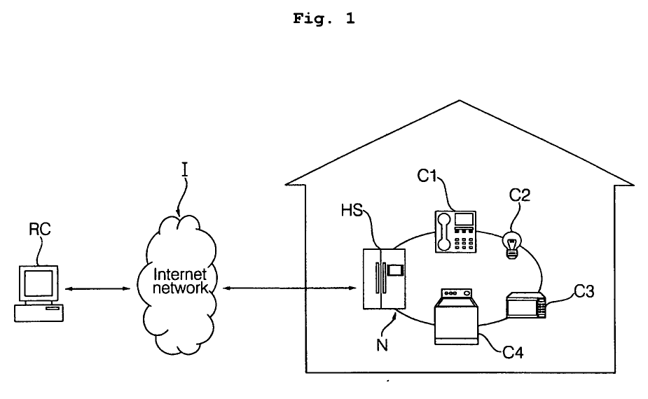

FIG. 2 is a block diagram illustrating the configuration of a home network system in accordance with the present invention;

FIG. 3 is a block diagram illustrating the detailed configurations of a home server appliance and a home server communication module shown in FIG. 2; and

FIG. 4 is a flowchart illustrating an operation of the home network system in accordance with the present invention.

### DESCRIPTION OF THE PREFERRED EMBODIMENTS

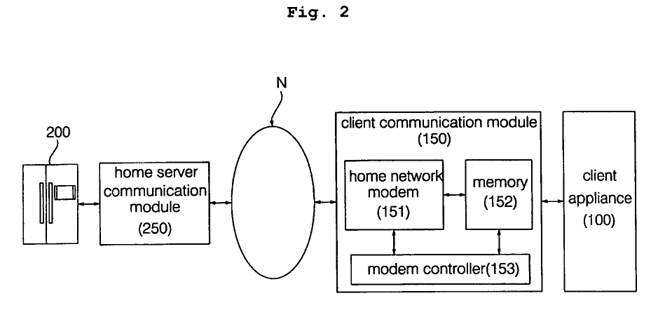

Now, preferred embodiments of the present invention will be described in detail with reference to the annexed drawings. FIG. 2 is a block diagram illustrating the configuration of a home network system in accordance with the present invention.

A client appliance 100 connected to a home network N includes a built-in microcomputer whose serial number is assigned by a manufacturer. In this case, the microcomputer controls an overall operation of the client appliance 100. Furthermore, when receiving the control command through the home network N, the microcomputer controls the client appliance in response to the control command. If necessary, the microcomputer generates response data corresponding to the control command and performs a function of transmitting the response data to the home network N.

A home server appliance 200, e.g., a refrigerator, can input a control command into a plurality of home appliances 100, connected to the home network N, other than the refrigerator, and externally outputs a result of the control operation performed in response to the control command so that a manager of the home network N can confirm the result of the control operation. Further, the home server appliance 200 has sufficient processing capacity required for processing signals to be transmitted to and received from the client appliances 100. Furthermore, the home server appliance 200 includes a memory, an input unit for receiving a control command, and an output unit for outputting the result of a control operation.

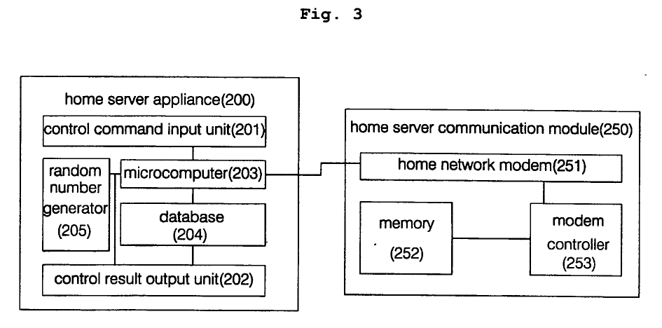

As shown in FIG. 3, the home server appliance 200 includes a control command input unit 201 for allowing a manager or a user of the home appliances to input a control command; and a control result output unit 202 for allowing the manager or user to confirm response data transmitted from each client appliance having received the control command through the home network N.

The home server appliance 200 recognizes IDs (Identifiers and Identities) of the client appliances connected to the home network N to discriminate the client appliances. The home server appliance 200 receives a manufacturer's serial number of a client appliance 100 newly connected to the home network N and determines whether the manufacturer's serial number of the newly connected client appliance 100 is equal to an ID of another client appliance. If the manufacturer's serial number of the newly connected client appliance 100 is equal to an ID of another client appliance 100 as a result of the determination, the home server appliance 200 generates a random number and assigns the generated random number to as an ID of the newly connected client appliance 100, such that the newly connected client appliance 100 is automatically bound to the home network N.

In addition to the control command input unit 201 and the control result output unit 202, the home server appliance 200 includes a microcomputer 203 for controlling an overall operation of the home server appliance 200, a database 204 for storing IDs of the client appliances 100 connected to the home server appliance 200 through the home network N, and a random number generator 205 for generating a random number as an ID to be assigned to a client appliance 100 if necessary.

Where a new client appliance 100 is connected to the home network N, the microcomputer 203 determines whether a manufacturer's serial number of the new client appliance 100 is equal to an ID stored in the database 204. If the manufacturer's serial number of the new client appliance 100 is not equal to any ID stored in the database 204, the microcomputer 203 assigns the manufacturer's serial number as the ID to the new client appliance 100 and stores information of the assigned ID in the database 204. Then, the microcomputer 203 transmits the assigned ID information to the new client appliance 100.

On the other hand, if the manufacturer's serial number of the new client appliance 100 is equal to an ID stored in the database 204, the microcomputer 203 accesses the random number generator 205, generates an ID to be assigned to the new client appliance 100, assigns the generated ID to the new client appliance 100 and stores information of the assigned ID in the database 204. Then, the microcomputer 203 transmits the assigned ID information to the new client appliance 100.

The client appliance 100 further includes a communication module 150 connected thereto in series so that the client appliance 100 transmits and receives signals through the home network N. The communication module 150 includes a home network modem 151 for carrying out a communication protocol conversion for signals to be transmitted and received between the client appliance 100 and the home server appliance 200; a memory 152 for storing a unique ID assigned to the client appliance 100 by the home server appliance 200; and a modem controller 153 for controlling the home network modem 151 so that a control signal is received from the home server appliance 200 on the basis of the ID assigned to the client appliance 100 and is transmitted to the client appliance 100.

Preferably, the memory 152 stores the unique ID irrespective of a power on/off operation and is implemented with an EEPROM (Electrically Erasable and Programmable Read Only Memory) in which the stored unique ID can be deleted in response to a reset command. The client appliance's unique ID once recognized is continuously stored in the memory 152 before the manager arbitrarily presses a reset switch.

Similarly, the home server appliance 200 communicates data with the home network N through a home server communication module 250. The home server communication module 250 includes a home network modem 251 for converting a format of data to be transmitted and received between the home server appliance 200 and the home network N; a memory 252 for storing a manufacturer's serial number given to the microcomputer 203 of the home server appliance 200 as an ID of the home server appliance 200 provided in the home network N; and a modem controller 253 for controlling a data transmission and reception operation of the home network modem 251.

Where the home server appliance 200 transmits an ID through the home network N, the client communication module 150 connected to the client appliance 100 recognizes the transmitted ID as the ID of the client appliance 100 and stores information of the recognized ID in the memory 152.

A control command inputted through the home server appliance 200 is transferred to the client communication module 150 serially connected to the client appliance 100 to be controlled through the home network N. The client communication module 150 converts a format of a control command signal into a signal format recognizable in the client appliance 100 through a communication protocol conversion so that the home appliance 100 can be controlled in response to the control command signal. The client communication module 150 receives a result of the control operation from the client appliance 100 to transmit the result of the control operation to the home server appliance 200. The result of the control operation associated with the client appliance 100 is externally outputted through the home server appliance 200.

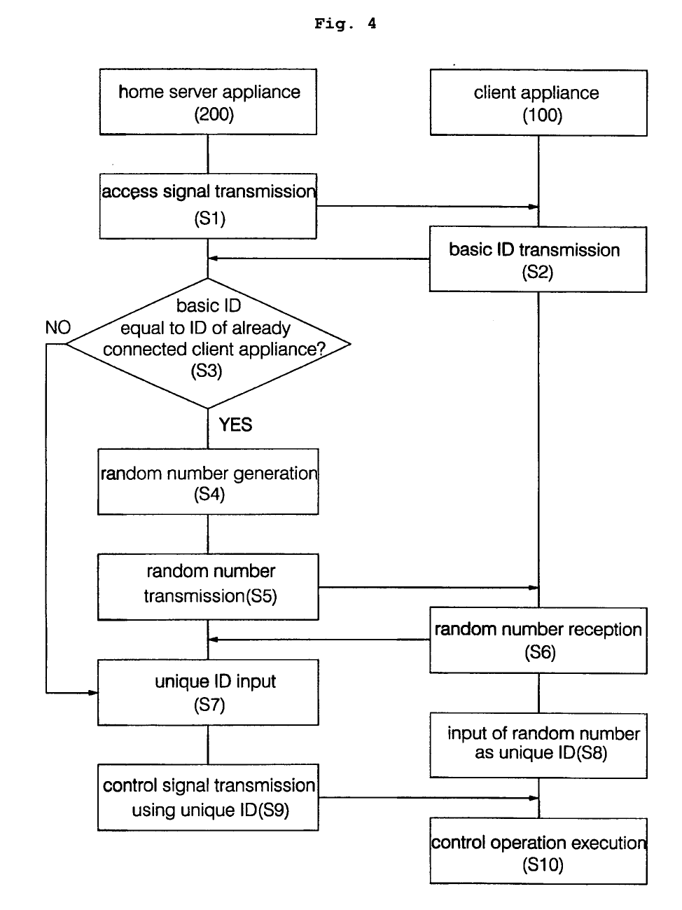

Operation of the above-described home network system in accordance with the present invention will now be descried with reference to FIG. 4.

At the first stage, a home server appliance transmits an access signal required for controlling a client appliance newly connected to a home network to the newly connected client appliance (S1).

At the second stage, the manufacturer's serial number of a microcomputer embedded in the newly connected client appliance having received the access signal, i.e., a basic ID (Identifier or Identity), is transmitted to the home server appliance (S2). The home server appliance receives the basic ID of the newly connected client appliance, and determines whether the basic ID of the newly connected client appliance is equal to an ID of a home appliance already connected to the home network (S3).

If the basic ID of the newly connected client appliance is not equal to any ID of the already connected home appliance as a result of the determination, the basic ID is inputted as a unique ID of the newly connected client appliance (S7). On the other hand, if the basic ID of the newly connected client appliance is equal to any ID of the already connected home appliance, the home server appliance generates a random number (S4) and then transmits the generated random number as the unique ID to the newly connected client appliance (S5).

At the third stage, the newly connected client appliance receives the unique ID from the home server appliance and transmits an acknowledgement signal ACK to inform the home server appliance of the fact that the unique ID has been appropriately received, and the home server appliance inputs the unique ID (S7). Then, upon inputting the unique ID into a memory, the newly connected client appliance recognizes the unique ID assigned by the home server appliance (S8).

At the fourth stage, the home server appliance invokes the unique ID newly assigned thereby and inputs a control command for controlling the client appliance (S9). Then, the client appliance performs an operation in response to the control command (S10). The client appliance transmits a result of the control operation to the home server appliance, and a manager can confirm the result of the control operation through the home server appliance.

As apparent from the above description, the present invention provides a method for operating a home network system, which can automatically input the manufacturer's serial number of a microcomputer, embedded in a client appliance newly connected to a home network, as a basic ID (Identifier or Identity) into a home server appliance, arbitrarily generate a random number if the basic ID is equal to an ID of another client appliance, and assign the generated random number as a unique ID to the newly connected client appliance, such that a plurality of client appliances can be stably and reliably controlled, a manual ID input procedure by a user can be omitted, and convenience of the user can be improved.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A home network system for generating a random number, comprising:
a plurality of client appliances connected to a home network, each of the client appliances being controlled in response to a received control command;
a plurality of client communication modules for converting a format of data to be transmitted and received between the client appliances and the home network;
a home server appliance for inputting the control command into each of the client appliances, assigning a manufacturer's serial number of the client appliance as an ID (Identifier or Identity) of the client appliance, generating a random number if the manufacturer's serial number of the client appliance is equal to an ID of another client appliance, and assigning the generated random number as the ID of the client appliance; and
a home server communication module for converting a format of data to be transmitted and received between the home server appliance and the home network.

2. The home network system as set forth in claim 1, wherein the home server appliance comprises:
a database for storing IDs of the client appliances connected to the home network;
a random number generator for generating the random number if the manufacturer's serial number is equal to an ID stored in the database; and
a microcomputer for accessing the database and the random number generator and assigning an ID to a client appliance newly connected to the home network.

3. The home network system as set forth in claim 2, wherein the home server appliance further comprises:
a control command input unit for receiving the control command for the client appliance; and
a control result output unit for outputting control state information if the control state information is received from the client appliance.

4. The home network system as set forth in claim 1, wherein the home server communication module comprises:
a memory for storing address information of the home server appliance on the home network;
a modem for converting data to be transmitted and received between the home server appliance and the home network into a format based on an appropriate protocol; and
a modem controller for controlling the modem.

5. The home network system as set forth in claim 1, wherein each of the client communication modules comprises:
a memory for storing information of an ID assigned to the client appliance by the home server appliance;
a modem for converting data to be transmitted and received between the client appliance and the home network into a format based on an appropriate protocol; and
a modem controller for controlling the modem.

6. A method for controlling a home network system that generates a random number, comprising the steps of:
(a) allowing a client appliance newly connected to a home network to transmit information of a manufacturer's serial number to a home server appliance;
(b) allowing the home server appliance to assign, to the client appliance, an ID (Identifier or Identity) based on the manufacturer's serial number of the client appliance or a random number generated through a random number generation operation; and
(c) allowing the client appliance to store the ID and allowing the home server appliance to transmit a control command using the ID.

7. The method as set forth in claim 6, wherein the step (a) comprises the steps of:
allowing the home sever appliance to transmit an access signal to the client appliance; and
allowing the client appliance having transmitted the access signal to transmit its own serial number to the home server appliance.

8. The method as set forth in claim 6, wherein the step (b) comprises the steps of:
allowing the home server appliance to compare the transmitted serial number with an ID of a client appliance already connected to the home network;
if the transmitted serial number is equal to an ID of a client appliance already connected to the home network, generating the random number as the ID of the newly connected client appliance and assigning the ID of the newly connected client appliance; and
if the transmitted serial number is not equal to an ID of any client appliance already connected to the home network, assigning the transmitted serial number as the ID of the newly connected client appliance.

9. The method as set forth in claim 8, wherein the step (b) further comprises the step of:
storing the assigned ID in a client communication modem connected to the newly connected client appliance.
